(19) United States
(12) Patent Application Publication
(10) Pub. No.: US 2014/0319794 A1
(43) Pub. Date: Oct. 30, 2014

(54) VEHICLE STEP ASSEMBLY

(71) Applicant: International Truck Intellectual Property Company, LLC, (US)

(72) Inventors: Rob Sandy Mullas, Lisle, IL (US); Ian William Cramer, Lisle, IL (US); Robert Eugene Newman, JR., Garrett, IN (US); Patrick J. Gorman, Bradenton, FL (US)

(73) Assignee: International Truck Intellectual Property Company, LLC, Lisle, IL (US)

(21) Appl. No.: 13/872,402

(22) Filed: Apr. 29, 2013

(51) Int. Cl. B60R 3/02

(52) U.S. Cl. CPC B60R 3/02
USPC 280/166

(57) ABSTRACT

An impact resistant collapsible step assembly for use with a high profile vehicle is described. The step assembly includes an elongate support member or first step having a first and a second opposing ends, a step platform or second step positioned adjacent to the support member, the step platform having first and second opposing ends, first and second upper retention members secured to the first and second ends of the support member, first lower and second lower retention members secured to the opposing ends of the step platform, and, least one flexible connection member attached to the upper and lower retention members for releasably securing the step platform relative to the support member, wherein the connection member collapses the step platform upon impact with an external object.

### TECHNICAL FIELD

The present device relates to a step assembly for use in entering and leaving a vehicle. Specifically, the device relates to a step assembly, a portion of which is collapsible upon impact.

### BACKGROUND

Many classes of vehicles are raised off the ground to an extent that may make it difficult to enter the vehicle cab or access portions of the vehicle. Such vehicles, trucks, or even military vehicles, including mine resistant ambush protected (MRAP) vehicles, may be equipped with accessories such as externally mounted side boards, running boards, side bars, or other step assemblies to provide a surface upon which a person may step, and/or stand when attempting to access the cab or other portion of the vehicle.

MRAP vehicles and other military vehicles are typically designed to handle off-road activities, which often involve maneuvering through all types of conditions including dirt, uneven terrain, mud, bodies of water, snow and ice. Externally mounted side boards or steps used on these vehicles can be prone to damage or even destroyed if they happen to impact the ground or other objects. Major repairs and/or replacement of the steps and adjacent components may be necessary, which can involve both considerable time and expense, and may not be conducive in the field.

Therefore, there is a need for a step assembly, which will permit easy access to the vehicle, but have a simple installation and be easily serviceable in the field. In addition, there is a need to for a step that upon impact with the ground or another object, has a collapsible design that minimizes the damage to the step itself and the upper support step. Alternatively, the step may break away from the support member upon impact. The present assembly provides such a step assembly having these attributes, as well as, low cost and weight and simple installation and replacement.

### SUMMARY

Generally speaking, the present device is a step assembly for connection and use with a high profile vehicle, which is capable of collapsing or completely releasing from a support structure when the device impacts the ground or an object.

In an embodiment of the step assembly, the assembly includes an elongate support member having a first and a second opposing ends, a first mounting bracket and a second mounting bracket, each mounting bracket secured to the support member, a step platform positioned adjacent to the support member, the step platform having first and second opposing ends, first and second upper retention members secured to the first and second ends of the support member, first lower and second lower retention members secured to the opposing ends of the step platform, and at least one flexible strap attached to the upper and lower retention members for releasably securing the step platform relative to the support member, wherein the strap collapses the step platform upon impact with an external object.

In yet another embodiment of a vehicle step assembly, the assembly includes a first step secured to a vehicle structure by at least one mounting bracket, a second step positioned adjacent to the first step, a first set of retention plates secured to the first step, a second set of retention plates secured to the second step; and, at least one connection member attached to the first and second set of retention plates, wherein the connection member releasably secures the second step to the first step.

### BRIEF DESCRIPTION OF THE DRAWINGS

FIG. 1 is a perspective view of the collapsible step assembly of the present disclosure;

FIG.2 is a close-up view of one of the upper retention plates;

FIG. 3 is a bottom view of the step platform or second step of the present step assembly;

FIG. 4 is a side view of the collapsible step assembly of the present disclosure; and,

FIG. 5 is a top view of the step platform or second step of the present step assembly.

### DETAILED DESCRIPTION

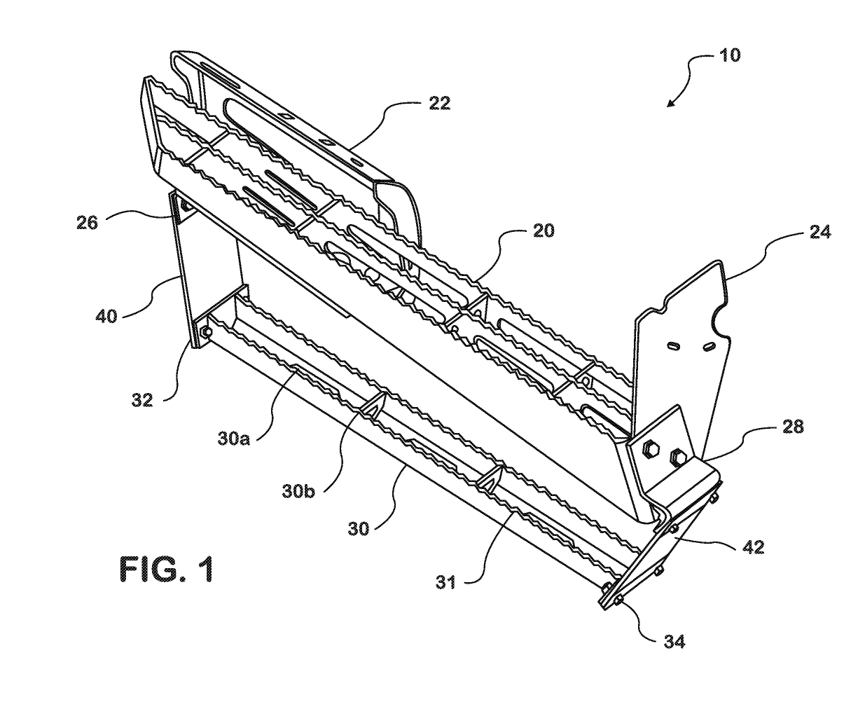

Referring to FIGS. 1-5, there is illustrated the step assembly of the present disclosure, generally designated by the numeral 10, as well as its associated components. The step assembly 10 is useful for accessing vehicles, including high profile vehicles such as trucks, MRAP and other military vehicles.

Referring now to FIGS. 1-5, an embodiment of the step assembly 10 and its components can be more readily understood. Initially, the step assembly 10 includes an elongate support member 20. The elongate support member forms the first or top step of the step assembly 10. The first or top step 20 can be constructed of any type of durable material, such as steel or aluminum. FIG. 1 shows the top step having a grated or rough stepping surface, which is useful for traction on the step. However, it is understood that the top step 20 can have any useful design and stepping surface. Additionally, the length of the support member can vary depending on vehicle requirements, but should have enough length to accommodate at least one shoe or boot width.

At least one bracket 22, 24 is secured to the support member 20, using know fasteners, such as bolts or screws. While two brackets are shown, it is understood that any number of brackets may be used to secure the step assembly to a vehicle. The bracket or brackets 22, 24, mount the support member 20 to the vehicle (not shown), also by known fasteners. Placement of the step assembly 10 on the vehicle can vary depending on the structural requirements of the vehicle, and where it is most convenient for personnel to access the vehicle.

The step assembly 10 further includes a step platform or second step 30 positioned in close proximity to the support member 20. FIGS. 3 and 5 show a bottom and top view, respectively, of the step platform. The step platform 30 is generally positioned directly below or slightly below, or angled outward from the support member (as generally found in a typically step arrangement), and is the first step encountered by the persons entering the vehicle. The step platform 30 can be any length to accommodate at least one shoe or boot width.

In this particular embodiment, the step platform or second step 30 is not one continuous piece of material, but has a series of openings 30a separated by supporting bars 30b along the length of the step. Constructed in this manner, the second step is strong, lightweight and cost-effective as less material is used in the construction of the step. Alternatively, the second step 30 may be constructed from a continuous piece of material. In addition, the “step” portion of the step platform or second step generally has uneven, rough or grated edges 31, which provides additional traction on the step.

The second step 30 is the portion of the step assembly 10 which is closest to the ground, and therefore is likely to encounter the ground, particularly over rough or uneven terrain. For this reason, it would be useful for the second step 30 to have the ability to either collapse when it hits the ground, or break away completely from the support member 20. Furthermore, if this were to happen, it would be advantageous that the collapse or break away minimally affects the support member 20, and that the second step and its connections to the support member are easily replaceable, if needed.

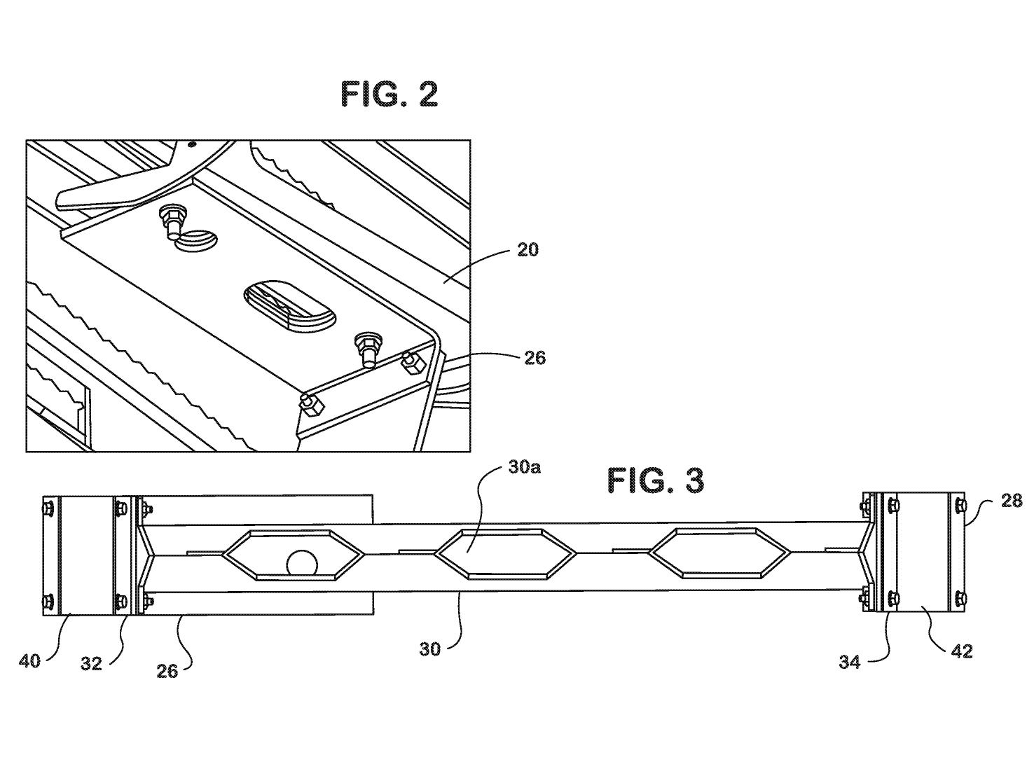

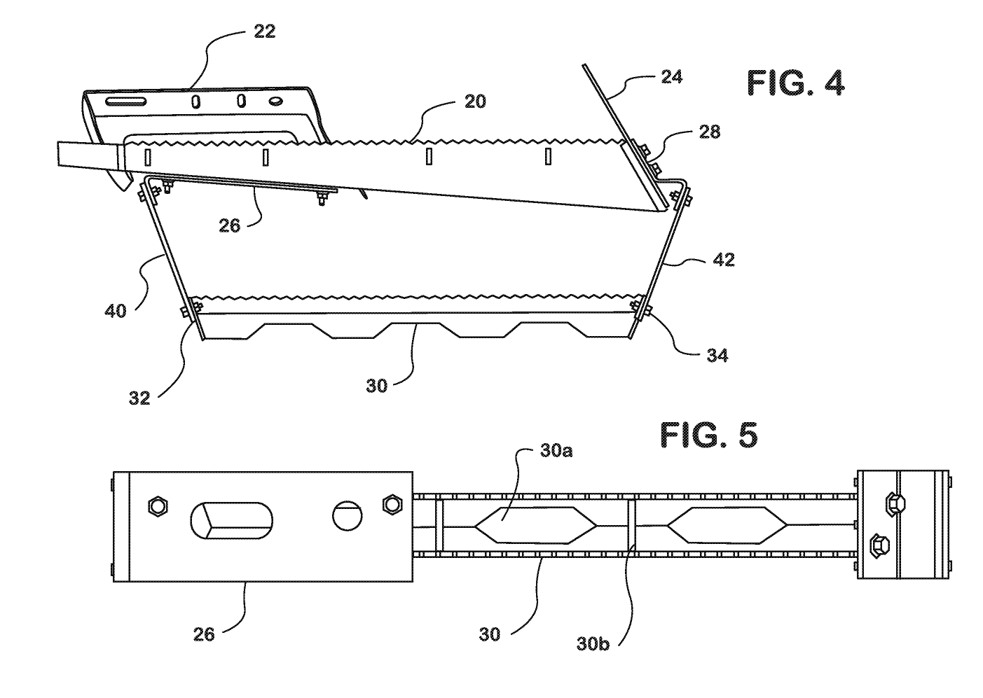

To accomplish these features, the present step assembly incorporates connection members in the form of straps 40, 42, which are used to connect the support member 20 to the step platform 30 (FIGS. 1 and 4). The straps 40, 42 are connected to the support member 20 through at least a pair of upper retention plates 26, 28, and to the second step or step platform 30 through at least a pair of lower retention plates, 32, 34. FIG. 2 shows one embodiment of the retention plate attached to the underside of the support member 20. FIG. 4 provides a side view of the second upper retention plate 28, which is attached to an end of the support member. Connection of the straps 40, 42 to the respective retention plates is accomplished through known fasteners, such as nuts and bolts or screws. The number of retention plates, their particular shapes and attachment to the support member and second step may vary depending on specific requirements; however, the simplicity of the design and ease of removal and attachment of the step platform 30 and/or straps should be considered.

Because one of the features of the present step assembly 10 is that the second step or step platform 30 is collapsible upon impact, the straps 40, 42 are constructed from a flexible material, such as rubber. Use of a thicker rubber insures that the step will not travel cross vehicle when stepped on. Optionally, the sides of the straps may be reinforced with nylon, or again, any suitable material that bends or collapses upon impact. As shown in the embodiment of FIG. 4, the straps 40, 42 are mounted forming an angle, for example, from the support member 20 to the step platform 30. Mounting the connection members or straps in an angled formation helps to prevent the step 30 from swinging forward and aft when stepped on. Alternatively, the straps 40, 42 may be connected perpendicular to the ends of the support member 20 and the platform step 30.

Use of straps 40, 42 made from a flexible material provides the second step 30 with the ability to bend or flex upon contact with the ground or an object. Alternatively, the straps may break releasing the second step from the support member 20, with minimal or no damage to the support member. Thus, the present step assembly 10 provides a low cost, low weight alternative with simple installation and easy serviceability over standard fixed step assemblies.

What is claimed is:

1. A step assembly for use on a vehicle comprising:
an elongate support member having a first and a second opposing ends;
a first mounting bracket and a second mounting bracket, each mounting bracket secured to the support member;
a step platform positioned adjacent to the support member, the step platform having first and second opposing ends;
first and second upper retention members secured to the first and second ends of the support member;
first and second lower retention members secured to the opposing ends of the step platform; and,
at least one flexible strap attached to each of the upper and lower retention members for releasably securing the step platform relative to the support member, wherein the strap collapses the step platform upon impact with an external object.

2. The step assembly of claim 1, wherein the support member is an upper step platform.

3. The step assembly of claim 1, wherein the first upper retention member is disposed beneath the first end of the support member and offset from the first lower retention member.

4. The step assembly of claim 1, wherein the second upper retention member is disposed on the second end of the support member and off-set from the second lower retention member.

5. The step assembly of claim 1, wherein the flexible strap connects between the first upper retention member and the first lower retention member.

6. The step assembly of claim 1, wherein the flexible strap connects the second upper retention member and the second lower retention member.

7. The step assembly of claim 5, wherein the flexible strap is secured at an angle from the first upper retention member to the first lower retention member.

8. The step assembly of claim 6, wherein the flexible strap is secured at an angle from the second upper retention member to the second lower retention member.

9. The step assembly of claim 1, wherein the flexible strap comprises a rubber material.

10. A vehicle step assembly comprising:
a first step secured to a vehicle structure by at least one mounting bracket;
a second step positioned adjacent to the first step;
a first set of retention plates secured to the first step;
a second set of retention plates secured to the second step; and,
at least one connection member attached to the first and second set of retention plates,
wherein the connection member releasably secures the second step to the first step.

11. The vehicle step assembly of claim 10, wherein the connection member comprises a flexible material.

12. The vehicle step assembly of claim 11, wherein the flexible material is a reinforced rubber.

13. The vehicle step assembly of claim 10, wherein in the connection member and the second step are collapsible upon impact.

14. The vehicle step assembly of claim 10, wherein the first set of retention plates are positioned off-set from the second set of retention plates.

15. The vehicle step assembly of claim 14, wherein the connection member is set at an angle between the first and second set of retention plates.
